(19) United States
(12) Patent Application Publication
(10) Pub. No.: US 2004/0122849 A1
(43) Pub. Date: Jun. 24, 2004

(54) Assignment of documents to a user domain

(75) Inventor: Kenneth Carlin Nelson, Hollister, CA (US)

Correspondence Address: SUGHRUE MION, PLLC, 2100 PENNSYLVANIA AVENUE, N.W., SUITE 800, WASHINGTON, DC, 20037, US

(73) Assignee: International Business Machines Corporation, Armonk, NY

(21) Appl. No.: 10/327,205

(22) Filed: Dec. 24, 2002

(51) Int. Cl. G06F 17/00

(52) U.S. Cl. 707/102

(57) ABSTRACT

In a content management system, when a document is created, a system defined attribute for a domain is included as an attribute of the document. The content management system automatically extracts the domain associated with a user who created the document and inserts it into the domain field for the document. With this approach, it is not possible for an application program to incorrectly assign a domain to a newly created document, since the content management system automatically assigns the domain. Responses to requests by a user for access to documents within the content management system are filtered by a database view. The view is automatically selected based on the user's domain to limit access to items having the same domain as the user's domain. Accordingly, the user is provided access only to documents within the same domain as the user or in a public domain.

### BACKGROUND OF THE INVENTION

1. Field of the Invention

The invention relates to information storage and retrieval computer systems. More particularly, it relates to using domains in a content management system to control access to items stored in the system.

2. Description of the Related Art

A content management system is a computer-based infrastructure for managing the full spectrum of digital information. Large collections of scanned images, facsimiles, electronic office documents, XML and HTML files, computer output, audio, video, multimedia, and virtual reality content can be stored and accessed through the content management system. The content management system integrates content with line of business, customer service, enterprise resource planning (ERP), digital asset management, distance learning, World-Wide Web (“Web”) content management or other applications to accelerate benefits across the enterprise.

One instance of such a content manager system can be visualized as a triangle, its three vertices being the client, a library server and an object server (resource manager). The client provides the user's interface which gives the user the capability of storing, searching for, and, marking-up documents or other objects. The library server is the equivalent of a card catalog which holds information about the objects, including their location. The object server (OS), also referred to herein as the resource manager (RM) is where either the actual object or a pointer to the actual object is stored.

The core library server logic (except for system utilities and housekeeping tasks) is packaged as a set of relational data base (RDB) stored procedures (SPs) containing embedded SQL statements. Each stored procedure is precompiled and runs on a relational database (RDB) server. Thus, each library server process is a relational database server process. The interface to a library server is SQL, through which either stored procedures can be called or SQL SELECT statements (including cursor support) can be executed. Remote access to the library server is via a relational database client.

The resource managers (RMs) can support different/multiple access protocols. For example, the resource manager, or object server, supports the HTTP protocol. The basic information entities managed by the library server are “items.” “Items” as used herein come in two types, simple items and resource items. Resource items can have content associated with them that is stored in one or more resource managers. Resource items point to their content via resource uniform resource locator (URL) related data.

The library server and resource manager, or object server, are separate processes, often running on different machines. In operation, clients first contact the library server to create/update an index for an object, and to determine where the object is to be stored/replaced. The client then sends a request to the resource manager to store/replace the object.

In a document management system, permission to create or access documents is generally controlled by an access control mechanism and use of privileges. In conventional content management systems, a user must have the general privilege allowing creation of a document, plus a specific privilege within an access control list allowing creation of a given “type” of document. Retrieval is similar, first requiring the general privilege to retrieve documents and second, permission to retrieve the document based on the access control code of the document type or the document itself.

This model allows two levels of control: within the document type, or at the individual document level. While this is valuable, document level access control requires many more access control definitions, greatly increasing administrative effort and complexity. Often, all that is needed is an additional level of filtering to restrict access to documents of a single type to members of the group that owns those documents.

Accordingly, there is a need to limit access to documents in a content management system without requiring extensive administrative efforts to list individual users in access control lists associated with those documents.

### SUMMARY OF THE INVENTION

An embodiment of the invention relates to a method of storing an item in a content management system that is partitioned into a plurality of domains. The method includes identifying, among the plurality of domains, a user domain that is associated with a user requesting storage of the item. A domain among the plurality of domains is specified to associate with the item, and the item is stored in the content management system with the specified domain associated with the item.

Another embodiment of the invention relates to a method of accessing one or more items stored in a content management system. The method includes determining a user domain associated with a user requesting access to the items; identifying a database view based on the user domain; and processing the database view to limit the user's access to items held in the content management system that are associated with the user domain.

Features and advantages of the invention will become apparent upon consideration of the following descriptions and descriptive figures of specific embodiments thereof. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a block diagram of a content management system.

FIG. 2 is a diagram illustrating the concept of administrative domains within a content management system.

FIGS. 3A-3C are database tables within a content management system that supports administrative domains.

FIG. 4 is a flowchart illustrating a process for defining an item type that is associated with an administrative domain.

FIG. 5 is a flowchart illustrating a process for creating an item and associating a domain with that item.

FIG. 6 is a flowchart illustrating a process for defining a view based on a domain to limit a user's access to items stored in the content management system.

FIG. 7 is a flowchart illustrating a process for retrieving an item that is stored in a content management system that associates domains with those items.

### DETAILED DESCRIPTION

The embodiments described below are described with reference to the above drawings, in which like reference numerals designate like components.

To reduce the burden on system administrators and gain the benefit of improved productivity, responsiveness to users requests, accuracy and avoid possible security exposures, the content management system described here introduces the concept of administrative domains. A domain can be specified with a numeric identifier together with a name and description to be used to logically relate or isolate information. For example, in a content management system that is shared by 20 customers, each having their own forms and documents, 20 domains would be defined, one for each customer. By filtering resources by domain, these users assigned to a domain will not see or be able to access resources such as documents or other items assigned to another domain.

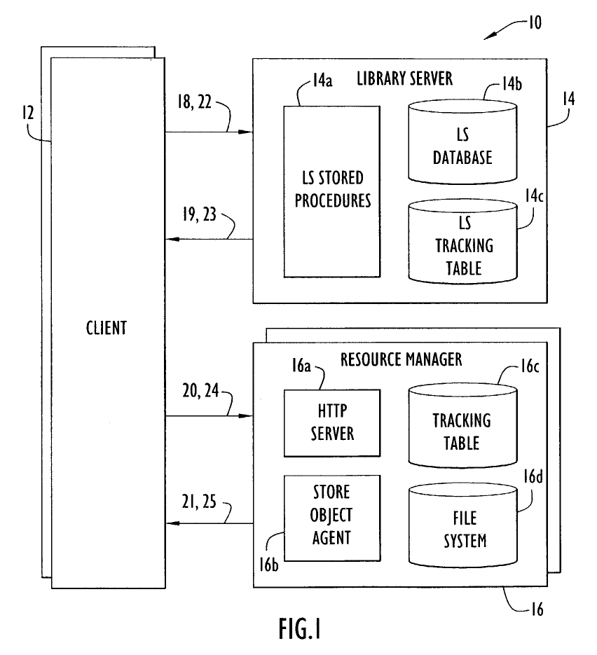

The problems with conventional content management systems can be overcome by partitioning administrative aspects of the system into domains. However, prior to describing domains it is helpful to understand the operation of the content management system shown in FIG. 1. Although the content management system shown in FIG. 1 is a client-server system, administrative domains can be used in systems that do not use a client-server architecture.

The content management system 10 shown in FIG. 1 illustrates one or more clients 12, a library server 14, and one or more resource managers 16, and how they interact to store an item. The library server includes library server stored procedures 14a, a library server database 14b, and a library server tracking table 14c. The resource manager includes an HTTP server 16a, a content management resource manager “Store Object” agent 16b, a resource manager tracking table database 16c, and a file system 16d.

A given object is defined by an entry in an index or list of objects with a unique identifier that is coupled with searchable attributes including a file or resource manager identifier and a collection identifier. The collection identifier describes how the object is to be managed for storage. A collection is a unit of storage: conceptually a cabinet where objects are placed. It may include many volumes of various storage media and a set of rules as to how the actual objects are stored and handled. The library server 14 and each of the plurality of resource managers 16 are used in the content management system 10 to manage digital content.

The library server 14 holds index, attribute and content information in a searchable form within the library server database 14b, which is a relational database. Generally the library server 14 contains a foldering system and references to data objects that may be stored in a resource manager or in other external file systems. The data objects may be any type of digital information, such as multimedia data. The library server 14 typically also contains a workflow system.

The library server 14 includes a plurality of tables that include content and administrative information. A resource manager table maintains information concerning the plurality of resource managers. A collection name table holds the names of each collection for each resource manager. A user table holds information concerning each user of the content management system. An item type table holds definitions of various types of items stored within the system. A component table contains a row for each item stored in the system and that row holds metadata that describe the item.

The resource managers 16 each have a file system 16d that holds objects as files or references to other storage systems. The resource manager provides for name translation from library server name to file system name/location and for hierarchical storage management and transport of objects. Each of the resource managers 16 also stores meta information that can be held in the file system or in transaction log files. Each resource manager includes an object server table in which a row exists for each object stored and managed by the resource manager. The row identifies the object and maps its identifier to a local filename.

At a high level, the client begins a transaction and returns confirmation to the end user. Next, the client establishes a connection to the library server, and sends requests 18 to the library server to create a catalog entry (as an index entry) for a content management object. In response, the client receives information 19 back from the library server as to where to store the object. For example, the library server returns to the client a URL for the resource manager where the object is to be stored, an object token, and other information. The client then sends a request 20, such as an HTTP request, to the resource manager to store the object. The client receives a response 21 from the resource manager with object metadata. This metadata includes, by way of exemplification, the object name, size, and creation timestamp. The client sends a message 22 with this metadata to the library server. The library server sends a reply 23 to the client indicating success or failure of the metadata update, at which point the client commits the library server updates. After committing the library server updates, the client sends a request 24 to the resource manager to delete its tracking table record. The client receives a reply 25 from the resource manager indicating success or failure in deleting the tracking table entry.

A similar process is followed when the client requests access to an object stored in the content management system.

To limit users' access to items in a content management system in support of organizational boundaries, a new content management system is described here that introduces the concept of administrative domains.

A domain is a section of a library server that one or more administrators manage. Domains relate to user IDs, user groups, privilege sets, access control lists, resource managers, and collections of items. Domains are not visible to users, but rather are used to simplify and enhance administrative tasks in operating a content management system and to limit users' access to items in the library based on their association with a domain.

Domains limit administrative and user access to only a subsection of the library server. Certain administrators assign each user to a domain in the content management system. For example, multiple organizations might share a content management system, with each organization assigned to a domain. The administrator for a domain associates each user within the administrator's organization to that organization's domain. Use of domains is transparent to users because they do not know that their access has been limited to only a part of the library server. Accordingly, users are aware only of items within that portion, or domain of the content management system to which those users are associated.

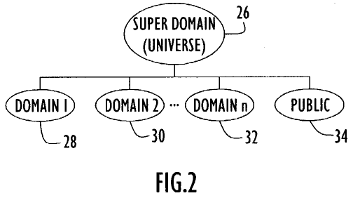

FIG. 2 is a conceptual illustration of the relationship of various domains in a content management system. The entire content management system is managed by a super administrator who has total privileges for and access to the entire system. In that regard, the entire content management system can be considered a super domain 26 corresponding to the universe of privileges and access controls. The super domain 26, corresponding to the universal set and encompassing the entire content management system, is managed by the super administrator. The content management system can be partitioned into domains 28, 30 and 32, each of which is named (e.g., Domain 1, Domain 2, Domain-n) and is managed by a subadministrator, also referred to as a domain administrator. A default domain 34 called Public, is a shared domain that is accessible by all administrators and users regardless of the domain to which they arc assigned. Partitioning the content management system into domains enables domain administrators to administer only a portion of the content management system while preventing their access to other portions; and it limits users access to items within the users' domains.

When users are defined to a content management system, each user can be associated with a domain. When a document is created, a system defined attribute for a domain is included as an attribute of the document. The content management system automatically extracts the domain associated with the user who created the document and inserts it into the domain field for the document. With this approach, it is not possible for an application program to incorrectly assign a domain to a newly created document, since the content management system automatically assigns the domain. Accordingly, there is not even a need for the application program creating a document to recognize the use of the domain field.

Although all documents of a single type are represented in one table in the content management system, a view is defined on that table that filters rows based on the domain attribute of documents. Use of views is limited by the access control mechanism of the content management system. By combining views and access control features, it is possible to restrict access to documents of a single type to users belonging to a single group or domain.

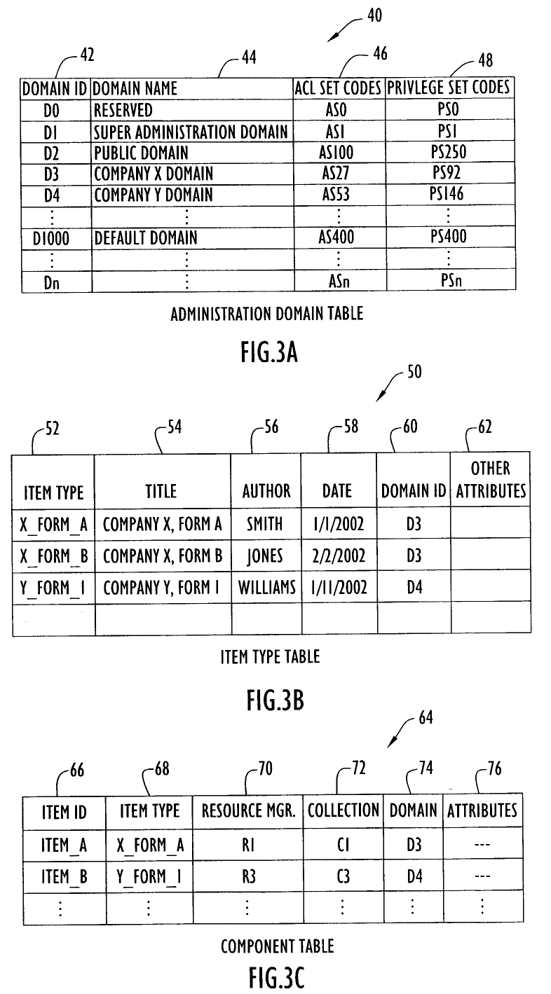

A domain table 40, shown in FIG. 3A, contains definitions of administrative domains within the content management system. The table includes a domain ID column 42 that contains the identifiers of all of the domains defined within the content management system. A domain name column 44 contains a name associated with each domain ID. Column 46 contains codes for access control list (ACL) sets. The access control list sets identify one or more access control lists. A privilege set code column 48 contains codes for privilege sets containing privileges for use in the content management system.

An item type table 102, held in the library server, is depicted in FIG. 3B. In order to limit a user's access to items within that user's domain, a system defined attribute DOMAINID is added. This is illustrated in FIG. 3B in which an item type table includes an item type 104 indicating the type of an item, such as a template for a form document. The table 102 also includes a title column 106 with the title of the item type, an author column 108, a date column 110 and the new domain ID column 112. Other columns for describing other attributes of the item type can be included as well, as illustrated in column 114.

A component table 64, held in the library server, is depicted in FIG. 3C. Each item stored in the content management system has a corresponding row in the component table 64. The row contains an item identifier 66 as well as metadata used to describe the item. For example, the component table contains an item type column 68 indicating the type of the item, a resource manager column 70 specifying the resource manager on which the item is recorded, and a collection ID column 72 indicating a storage collection on the resource manager in which the item is recorded. The component table is modified to include a domain ID column 74. The domain ID column specifies a domain with which the item is associated. For example, item A is associated with domain D3 and item B is associated with domain D4. The component table can include one or more other rows 76 with other attributes to describe the item.

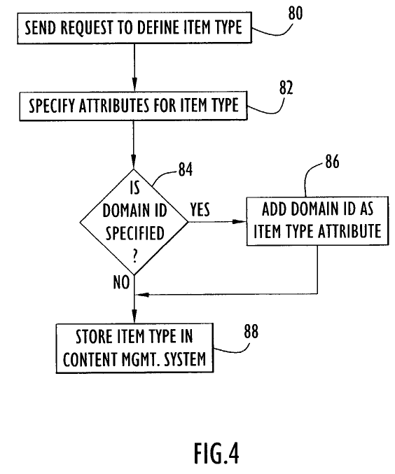

FIGS. 4 through 7 illustrate processes by which a domain ID is associated with an item type and also illustrate how users are limited to accessing only the item types that are defined for the user's domain or are defined for a public domain.

Referring to FIG. 4, a system administrator can send a request to the library server in the content management system to define a new item type, in operation 80. Part of this definition process includes specifying the attributes for the item type in operation 82. If a domain ID is specified as an attribute for the item type, in operation 84, the domain ID is added as an attribute for the item type in operation 86. However, if no domain ID is specified then the item type is stored in the content management system, in operation 88, without a domain ID. Alternatively, the domain ID of a default domain can be included as an attribute in the item type. Depending on the configuration of the content management system, if no domain ID is specified for an item type, the item type can be associated with a public domain that is shared by all users of the system.

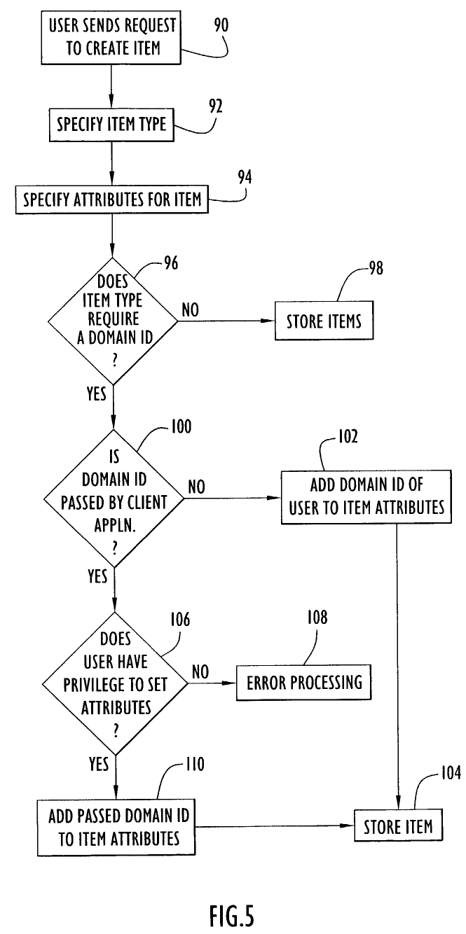

A user can create an item for which access is limited only to users associated with certain domains. This is illustrated in FIG. 5. Referring to FIG. 5, in operation 90 a user sends a request to the library server to create an item, such as a document. The user can specify the item type, in 92. As discussed above, a predefined item type can include attributes such as a domain ID. If that is the case, then the item will be associated with the domain ID for the specified item type. The user can further specify attributes to be associated with the item in operation 94.

In operation 96 the system determines whether a specified item type requires a domain ID. If not, the item is stored in the content management system in operation 98 in a conventional manner. However, if the specified item type requires a domain ID, then in operation 100 it is determined whether a domain ID is passed by the client application. If not, the domain ID of the user is added to the item's attributes in operation 102. The item is then stored in the content management system in operation 104. If the domain ID is passed by the client application, then in operation 106 it is determined whether the user has been granted the privilege to set attributes. If not, an error occurs and the error processing operation 108 is performed. If the user has the privilege to set attributes then the domain ID that was passed by the client application is added to the list of attributes for the item, in operation 110. The item is then stored in the system in operation 104.

Since item indices are held in one table, namely, the component table, a view can be defined on that table that filters the rows based on domain ID. In this manner, views can be used to restrict access to items, or documents within a single type, to users belonging to a single domain. Since views in the content management system are limited by the system's access control mechanism, views can be used to filter items, or documents, and thereby restrict access to those items or documents.

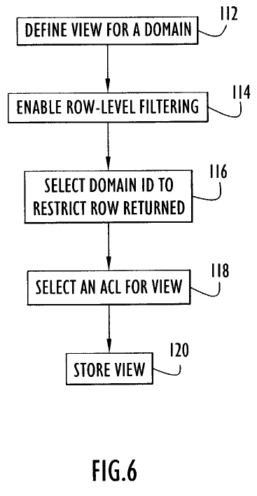

FIG. 6 illustrates a process for defining such a view to restrict access based on domain ID. In operation 112, a system administrator sends a request to the library server to define a view based on domain IDs. Once the view is created, the administrator can enable row-level filtering in operation 114. In this manner, when a user requests access to a document the view is executed to restrict access to only those items or documents having the same domain ID as the user's domain ID. In operation 116, the domain ID is selected in order to restrict the rows returned by the views. In operation 118, an access control list is selected for the view to control access to the view to allow only authorized users to access the view. Once the view is fully defined it is stored in the content management content system in operation 120.

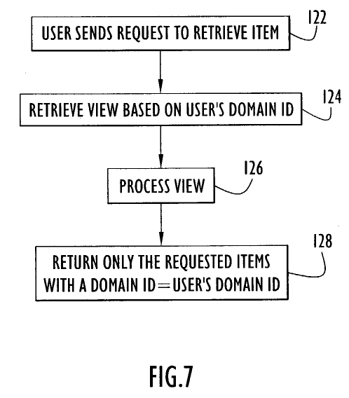

FIG. 7 illustrates a process for users requesting and retrieving items or documents from the content management system. In operation 122 the user sends a request to the library server to receive an item, such as a document. In operation 124, in response to the request, the library server causes the view to be accessed. The view that is accessed is retrieved based on the user's domain ID. More specifically, the view that has been defined for the user's domain ID is retrieved. The view is then executed in operation 126, and in operation 128 the responses to the requests are filtered based on the view. In this manner, only the requested items with a domain ID the same as the user's domain ID is returned. Accordingly, users are restricted to accessing only the items, or documents designated for the domain with which the user is associated.

Domains that are designated as public domains are accessible by all users of the content management system. Accordingly, the database views discussed above can be structured to allow any user to access items associated with a public domain in addition to accessing items associated with the requesting user's domain.

Having described apparatuses, articles of manufacture and methods of using domains in a content management system to control access to items stored in the system, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

What is claimed is:

1. A method of storing an item in a content management system partitioned into a plurality of domains, the method comprising:
identifying among the plurality of domains a user domain that is associated with a user requesting storage of the item;
specifying a domain among the plurality of domains to associate with the item; and
storing the item in the content management system with the specified domain associated with the item.

2. The method according to claim 1, wherein said specifying a domain is performed automatically by the content management system to specify the user domain as the domain to associate with the item.

3. The method according to claim 1, wherein a request to store the item includes a requested domain identifier to associate with the item, and said specifying a domain specifies the requested domain if the user has been granted a privilege to set item attributes.

4. The method according to claim 1, further comprising determining if the user has been granted a privilege to store the item in the content management system, and preventing storage of the item if the privilege to store the item has not been granted.

5. The method according to claim 1, wherein the item is a multimedia object.

6. A method of accessing one or more items stored in a content management system, comprising:
determining a user domain associated with a user requesting access said one or more items;
identifying a database view based on the user domain;
processing the database view to limit the user's access to items held in the content management system that are associated with the user domain.

7. The method according to claim 6, wherein said one or more of the items stored in the content management system are each associated with a domain, and the view operates to filter a response to the user's request so that only identifiers for items associated with the user domain are returned in response to the user's request.

8. The method according to claim 6, further comprising determining if the user is authorized to use the database view, and processing the database view only if the user is determined to be authorized to use the database view.

9. The method according to claim 8, wherein said determining if the user is authorized to use the database view is performed by determining if the user is specified in an access control list associated with the view.

10. The method according to claim 6, wherein the item is a multimedia object.

11. The method according to claim 6, wherein said processing the database view allows the user access to items held in the content management system that are associated with a public domain.

12. A program product embodied on a computer-readable medium of instructions for accessing one or more items stored in a content management system, comprising:
program instructions for determining a user domain associated with a user requesting access said one or more items;
program instructions for identifying a database view based on the user domain;
program instructions for processing the database view to limit the user's access to items held in the content management system that are associated with the user domain.

13. The program product according to claim 12, wherein said one or more of the items stored in the content management system are each associated with a domain, and the view operates to filter a response to the user's request so that only identifiers for items associated with the user domain are returned in response to the user's request.

14. The program product according to claim 12, further comprising program instructions for determining if the user is authorized to use the database view, and processing the database view only if the user is determined to be authorized to use the database view.

15. The program product according to claim 14, wherein said determining if the user is authorized to use the database view is performed by determining if the user is specified in an access control list associated with the view.

16. The program product according to claim 12, wherein the item is a multimedia object.

17. The program product according to claim 12, wherein said processing the database view allows the user access to items held in the content management system that are associated with a public domain.
